(19) United States
(12) Patent Application Publication
(10) Pub. No.: US 2009/0070526 A1
(43) Pub. Date: Mar. 12, 2009

(54) USING EXPLICIT DISK BLOCK CACHEABILITY ATTRIBUTES TO ENHANCE I/O CACHING EFFICIENCY

(76) Inventors: R. Scott Tetrick, Portland, OR (US); Dale J. Juenemann, North Plains, OR (US)

Correspondence Address: CENTURY IP GROUP, INC. [Intel], C/O INTELLEVATE , LLC, P.O BOX 52050, MINNEAPOLIS, MN, 55402, US

(21) Appl. No.: 11/854,376

(22) Filed: Sep. 12, 2007

(51) Int. Cl. G06F 12/08

(52) U.S. Cl. 711/113; 711/E12.019

(57) ABSTRACT

A data caching method comprising identifying whether data stored in a first data block on a storage medium is cacheable; setting a first cacheability attribute associated with the first data block in a data structure to identify whether the data in the first data block is cacheable; monitoring I/O requests submitted for accessing target data in the first data block; determining whether the target data is cacheable based on the first cacheability attribute; and applying algorithms that implement cache policy to the target data, in response to determining that the target data is cacheable.

### FIELD OF INVENTION

This invention relates generally to nonvolatile memory disk caches in computer systems and, more particularly, to the use of cacheability attributes to explicitly disallow cache insertions on a block-by-block basis.

### BACKGROUND

In a computing system, the rate at which data is accessed from rotating media (e.g., hard disk drive, optical disk drive) (hereinafter “disk”) is generally slower than the rate at which a processor processes the same data. Thus, despite a processor's capability to process data at higher rates, the disk's performance often slows down the overall system performance, since the processor can only process data as fast as the data can be accessed on the disk.

A cache system may be implemented to at least partially reduce the disk performance bottleneck by storing selected data in a high speed memory location designated as the disk cache. Then, whenever data is requested, the system will look for the requested data in the cache before accessing the disk. This implementation improves system performance since data can be retrieved from the cache much faster than from the disk.

Even though accessing data from the disk cache is much faster than accessing data from the disk, the amount of data that can be inserted into the cache is limited because of the relatively small size of the cache. Thus, software algorithms are implemented to choose what data to insert into the cache in order to maximize cache efficiency.

The simplest algorithms use the data's logical block address (LBA), transfer size, and whether access to the disk involves a read or a write to determine cache policy. The above-mentioned methods need to be improved to allow for faster disk access rates.

### BRIEF DESCRIPTION OF THE DRAWINGS

Embodiments of the invention are understood by referring to the figures in the attached drawings, as provided below.

FIG. 1 is a block diagram of the system components in an exemplary computing system, in accordance with one embodiment.

FIG. 2 illustrates an exemplary logical representation of a disk cacheability array, in accordance with one embodiment.

FIG. 3 is a flow diagram of a method for using explicit cacheability attributes in disk caching, in accordance with one embodiment.

Features, elements, and aspects of the invention that are referenced by the same numerals in different figures represent the same equivalent, or similar features, elements, or aspects, in accordance with one or more embodiments.

### DETAILED DESCRIPTION OF EXEMPLARY EMBODIMENTS

The present disclosure is directed to systems and corresponding methods that facilitate explicit disk block cacheability to enhance I/O caching efficiency.

In accordance with one embodiment, a method for storing explicit disk block cacheability attributes to enhance I/O caching efficiency is provided. The method comprises identifying whether data stored in a first data block on a storage medium is cacheable; setting a first cacheability attribute associated with the first data block in a data structure to identify whether the data in the first data block is cacheable; monitoring I/O requests submitted for accessing target data in the first data block; determining whether the target data is cacheable based on the first cacheability attribute; and applying algorithms that implement cache policy to the target data, in response to determining that the target data is cacheable. The method may further comprise failing to apply algorithms that implement cache policy to the target data, in response to determining that the target data is not cacheable.

The data structure may be an array comprising a plurality of bits, wherein each bit represents a first and a second value associated with a cacheability attribute for a data block on the storage medium. The storage medium may be a rotatable storage medium. The first value may represent that that data stored in the associated data block is cacheable. The second value may represent that data stored in the associated data block is not cacheable. The first value may be approximately equal to “1”, and the second value may be approximately equal to “0”.

In accordance with one embodiment, a system comprising one or more logic units is provided. The one or more logic units are configured to perform the functions and operations associated with the above-disclosed methods. In yet another embodiment, a computer program product comprising a computer useable medium having a computer readable program is provided. The computer readable program when executed on a computer causes the computer to perform the functions and operations associated with the above-disclosed methods.

One or more of the above-disclosed embodiments, in addition to certain alternatives, are provided in further detail below with reference to the attached figures. The invention is not, however, limited to any particular embodiment enclosed.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

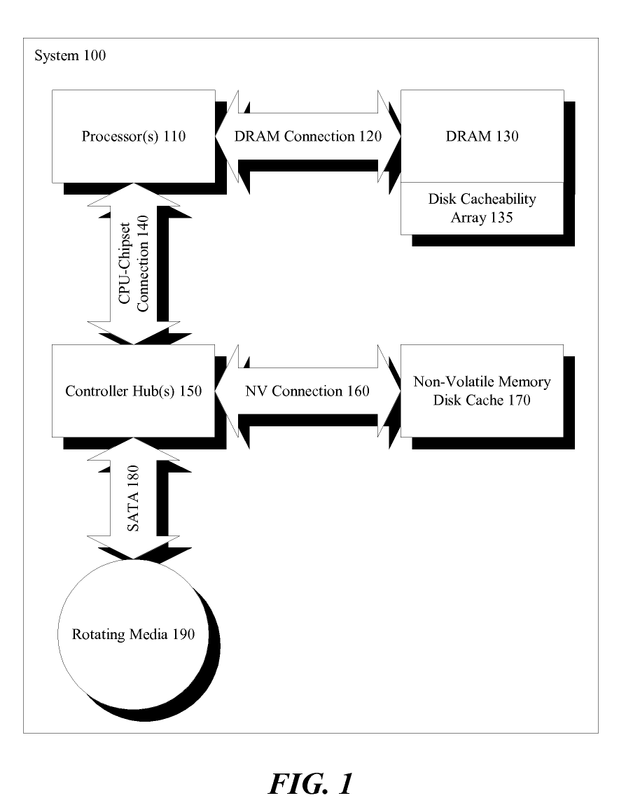

Referring to FIG. 1, exemplary system 100 comprises one or more processors 110, dynamic random access memory (DRAM) 130 for storing a disk cacheability array 135, controller hub(s) 150, nonvolatile memory disk cache 170, and rotating media 190. Rotating media 190 may comprise a hard disk drive (HDD) or an optical disk drive (ODD) depending on implementation. Disk cacheability array 135 may be loaded into main system memory, in accordance with one embodiment.

Processor(s) 110 may be connected to DRAM 130 by way of DRAM connection 120, for example, and processor(s) 110 may be connected to controller hub(s) 150 by way of chipset-cpu connection 140, for example. Controller hub(s) 150 may be connected to non-volatile (NV) memory disk cache 170 by way of NV connection 160, for example, and to rotating media 190 by way of serial advanced technology attachment (SATA) 180, for example.

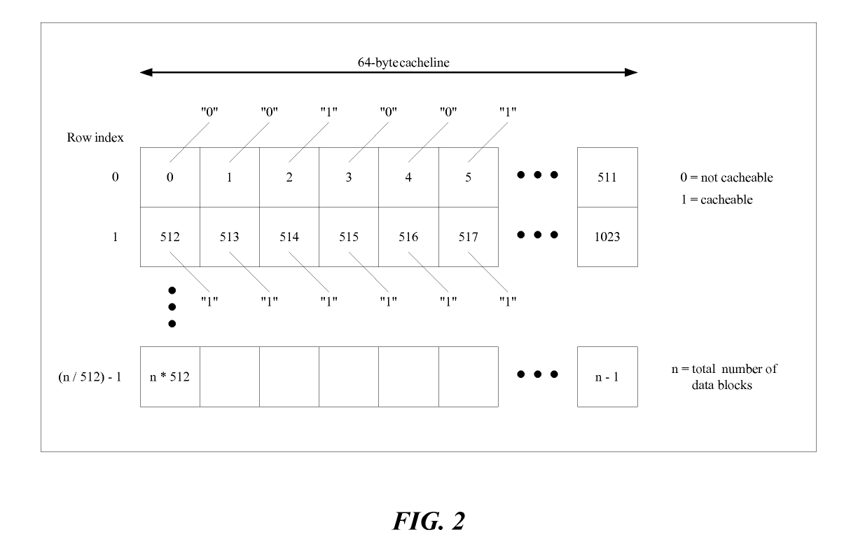

In one embodiment, disk cacheability array 135 may be implemented as a bitmap array, organized in, for example, cacheline length rows, as shown in FIG. 2. A bitmap array is a data structure with data stored in bit format where each bit is associated with, or mapped to, a key that can be used to look up the bit. Each bit represents an element of the bitmap array. A cacheline is the number of bits, or elements, per row.

As shown in FIG. 2, in an exemplary embodiment, a 64-byte cacheline may be provided to support the cacheability attributes of n logical block addresses (LBAs); n indicates the total number of data blocks in disk cacheability array 135. LBAs represent the location of data blocks stored on rotating media 190. Since 64 bytes is equal to 512 bits, each row has 512 elements, with n/512 rows total. Each element of the bitmap array may comprise a cacheability attribute (e.g., “0” or “1”). In an exemplary implementation, the value of “0” is assigned to the cacheability attribute, if the associated data block is not cacheable, and the value of “1” is assigned, if the associated data block is cacheable.

In one embodiment, each data block may have a corresponding cacheability attribute that can be determined in accordance with the data block's LBA. A system with a 200-gigabyte hard drive, for example, may have approximately 400 million LBAs. In a bitmap array implementation with one cacheability bit per LBA, the cacheability array takes about 50 megabytes of memory. Thus, the storage overhead of disk cacheability array 135 may be relatively small compared to the physical size of rotating media 190.

Disk cacheability array 135 may be stored in system 100's memory (e.g., DRAM 130). Accordingly, system 100's performance may be improved when system 100 uses cacheability attributes because accessing disk cacheability array 135 from DRAM 130 is faster than accessing rotating media 190.

In accordance with certain embodiments, if a data block is not cacheable, explicitly marking the data block as not cacheable by way of setting an associated cacheability attribute saves time by circumventing disk cache 170 altogether. That is, in such a scenario, it is faster to directly access rotating media 190 instead of applying the caching policy designated for accessing data through disk cache 170, when it can be determined in advance that the data in that data block is not cacheable (i.e., not in disk cache 170).

In alternative embodiments, disk cacheability array 135 may be implemented in a data structure other than the exemplary bit array illustrated in FIG. 2. For example, depending on implementation, other data structures such as linked lists, vectors, pointers, tables or other suitable data architectures may be utilized to implement disk cacheability array 135.

In some embodiments, a companion data structure in addition to disk cacheability array 135 may be provided. In an exemplary embodiment, each element of the companion data structure may, for example, be associated with one row of the disk cacheability array 135. When an entire row of disk cacheability array 135 is set as cacheable, the element in the companion data structure associated with that row is set to indicate that the entire row is cacheable. In an exemplary embodiment, such as the one illustrated in FIG. 2, where every element in row one is set to “1”, the element in the companion data structure associated with row one may also be set to “1”, indicating that row one comprises all ones, for example.

Using a companion data structure may speed up the performance of system 100 if the majority of data blocks on rotating media 190 are cacheable or, alternatively, if the majority of data blocks are not cacheable. In some cases, a single lookup in the companion data structure may eliminate the need for several lookups in disk cacheability array 135. For example, referring back to the bitmap array example in FIG. 2, if system 100 accesses data located on all the data blocks referred to by row one of disk cacheability array 135, system 100 may perform one lookup of the element in the companion data structure that is associated with row one, and determine that the data is all cacheable instead of looking up all 512 LBAs in row one of disk cacheability array 135.

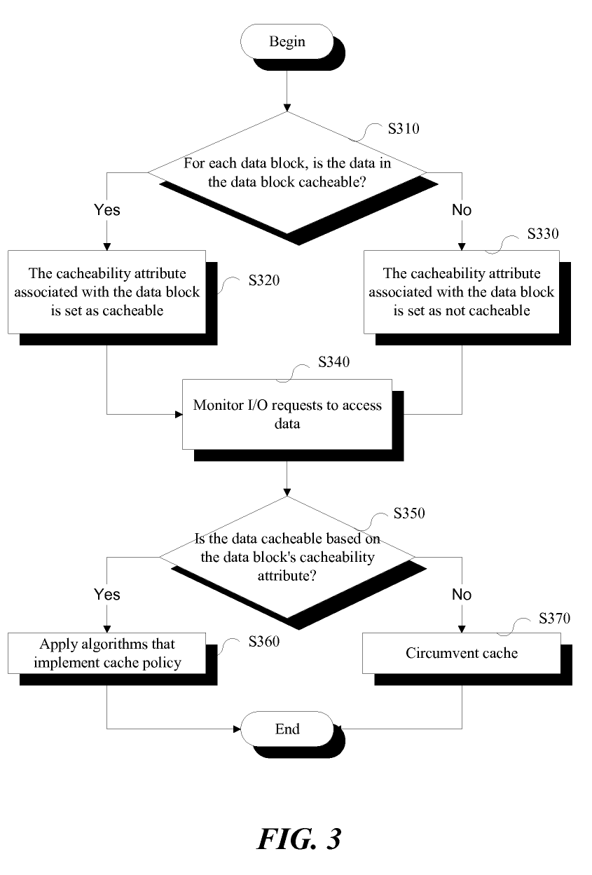

Referring to FIGS. 1 and 3, in accordance with one embodiment, an exemplary data caching method comprises identifying whether data stored in each data block is cacheable (S310). If a data block is cacheable, system 100 may be able to quickly access the data loaded in disk cache 170 before looking in rotating media 190. If a data block is not cacheable, the data in that data block is not loaded in disk cache 170; therefore, system 100 may access the data directly from the rotating media 190, instead of spending time to look in disk cache 170.

Depending on implementation, a data block may be considered cacheable when the data on the data block has been used recently or is likely to be used more than once. A data block may be considered not cacheable when the data on the data block is likely to be flushed, or replaced with new data, almost immediately, if the data was to be stored in disk cache 170.

Cache driver software or an operating system may, for example, determine whether a data block is cacheable. The operating system, in one embodiment, may identify installation files for an application as not cacheable because the installation files will probably not be used more than once. Thus, there would be no reason to load such files into disk cache 170 to begin with.

Referring back to FIGS. 1 and 3, the cacheability attributes for a data block may be set as provided below. If a data block is identified as cacheable, then the cacheability attribute associated with that data block is set as cacheable (S320). If a data block is identified as not cacheable, then the cacheability attribute associated with that data block is set as not cacheable (S330).

In one embodiment, when system 100 receives an I/O request to, for example, read data from a data block (S340), the data block's cacheability attribute in disk cacheability array 135 is examined (S350). If the data is cacheable, system 100 attempts to first read the data from disk cache 170, by applying algorithms that implement cache policy (S360). If the data is not loaded in disk cache 170, system 100 will read the data from rotating media 190. In some embodiments, if the data is not cacheable, system 100 circumvents disk cache 170 and directly reads the data from rotating media 190 (S370).

In the foregoing, one or more embodiments are disclosed as applicable to a read operation. It is noteworthy, however, that the principles and advantages disclosed herein may be equally applicable, with some modification, to a write operation or other operation involving data access to a rotating medium. As such, the exemplary embodiments disclosed herein should not be construed as limiting the scope of the invention.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may be comprise one or more modules that execute on one or more processors in a distributed, non-distributed, or multiprocessing environment.

The method as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections of buried interconnections). In any case, the chip is then integrated with other chips, discrete circuit elements, and/or other signal processing devices as part of either (a) an intermediate product, such as a motherboard, or (b) and end product. The end product can be any product that includes integrated circuit chips, ranging from toys and other low-end applications to advanced computer products having a display, a keyboard or other input device, and a central processor.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A data caching method comprising:
identifying whether data stored in a first data block on a storage medium is cacheable;
setting a first cacheability attribute associated with the first data block in a data structure to identify whether the data in the first data block is cacheable;
monitoring I/O requests submitted for accessing target data in the first data block;
determining whether the target data is cacheable based on the first cacheability attribute; and
applying algorithms that implement cache policy to the target data, in response to determining that the target data is cacheable.

2. The method of claim 1, further comprising circumventing cache to access target data, in response to determining that the target data is not cacheable.

3. The method of claim 1, wherein the data structure is an array comprising a plurality of bits, wherein each bit represents a first and a second value associated with a cacheability attribute for a data block on the storage medium.

4. The method of claim 1, wherein the storage medium is a rotatable storage medium.

5. The method of claim 3, wherein the first value represents that data stored in a corresponding data block is cacheable.

6. The method of claim 3, wherein the second value represents that data stored in a corresponding data block is not cacheable.

7. The method of claim 5, wherein the first value is approximately equal to “1”.

8. The method of claim 6, wherein the second value is approximately equal to “0”.

10. A data caching system comprising:
a logic unit for identifying whether data stored in a first data block on a storage medium is cacheable;
a logic unit for setting a first cacheability attribute associated with the first data block in a data structure to identify whether the data in the first data block is cacheable;
a logic unit for monitoring I/O requests submitted for accessing target data in the first data block;
a logic unit for determining whether the target data is cacheable based on the first cacheability attribute; and
a logic unit for applying algorithms that implement cache policy to the target data, in response to determining that the target data is cacheable.

11. The system of claim 10, further comprising a logic unit for failing to apply algorithms that implement cache policy to the target data, in response to determining that the target data is not cacheable.

12. The system of claim 10, wherein the data structure is an array comprising a plurality of bits, wherein each bit represents a first and a second value associated with a cacheability attribute for a data block on the storage medium.

13. The system of claim 10, wherein the storage medium is a rotatable storage medium.

14. The system of claim 12, wherein the first value represents that data stored in a corresponding data block is cacheable.

15. The system of claim 12, wherein the second value represents that data stored in a corresponding data block is not cacheable.
